(19) United States
(12) Patent Application Publication
(10) Pub. No.: US 2025/0016671 A1
(43) Pub. Date: Jan. 9, 2025

(54) MANAGEMENT OF DELIVERY OF POWER TO A RADIO HEAD

(71) Applicant: Telefonaktiebolaget LM Ericsson (publ), Stockholm (SE)

(72) Inventors: Hossein SHOKRI GHADIKOLAEI, Täby (SE); Lackis ELEFTHERIADIS, Valbo (SE); Rafia INAM, Västerås (SE); Burak DEMIREL, Älvsjö (SE); Zere GHEBRETENSAÉ, Trångsund (SE); Erik SANDERS, Vallentuna (SE)

(21) Appl. No.: 18/708,366

(22) PCT Filed: Nov. 9, 2021
(86) PCT No.: PCT/SE2021/051121

§ 371 Date: May 8, 2024

(51) Int. Cl. H04W 52/02; H04W 24/02; H04W 88/08

(52) U.S. Cl. CPC H04W 52/0206; H04W 24/02; H04W 88/085

(57) ABSTRACT

A method performed by a computing device in a communication system for management of delivery of power to at least one radio head from a local battery located proximate to the at least one radio head is provided. The method includes determining a decision about delivery of power from the local battery to the at least one radio head for a future time window. The decision made by a machine learning model based on (i) differentiation of output power data statistics including average power and peak power demands, and (ii) time and location dependent cost data of charging and/or discharging the local battery and power grid utilization. The method further includes outputting the decision about delivery of power from the local battery to the at least one radio head for the future time window.

### TECHNICAL FIELD

The present disclosure relates generally to methods for management of delivery of power to a radio head(s) from a local battery located proximate to the radio head(s), and related methods and apparatuses.

### BACKGROUND

A radio access network (RAN) is responsible for a large portion of energy consumption of mobile networks. Increasing a number of radio units in a RAN is a common approach to extend capacity and coverage to improve service quality. The addition of radio units can include more radio units of the same type and/or additional radio units for various radio access technologies (RATs) and bands. Such an approach, however, increases energy consumption.

In some approaches, site dimensioning (e.g., power cables, circuit breakers, power supply unit(s) (PSU)) is made based on a maximum radio power consumption of each radio unit, which can highly affect and increase an incoming site fuse(s) rating. Increasing a site fuse(s) rating can have a significant impact on the operational cost to the operator.

Future and existing RAN features (e.g., micro sleep transmission (Tx), Low Energy Scheduler Solution (LESS)), multiple-input-multiple-output (MIMO) sleep mode, cell sleep mode, etc.) increase a sleep time duration of radio units, which reduces power consumption. Such techniques can substantially increase a difference between average power consumption and peak power used by the installed radio units.

### SUMMARY

There currently exist certain challenge(s). There is a need for managing and/or delivering power in a way that enables the differentiation between average and peak power of radio heads, including while still adding new radio access technologies (RATs) in a sustainable way.

Certain aspects of the disclosure and their embodiments may provide solutions to these or other challenges.

In various embodiments, a method is provided that is performed by a computing device in a communication system for management of delivery of power to at least one radio head from a local battery located proximate to the at least one radio head. The method includes determining a decision about delivery of power from the local battery to the at least one radio head for a future time window. The decision is made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window. The method further includes outputting the decision about delivery of power from the local battery to the at least one radio head for the future time window.

In other embodiments, a computing device in a communication system for management of delivery of power to at least one radio head from a local battery located proximate to the at least one radio head is provided. The computing device includes at least one processor; and at least one memory connected to the at least one processor and storing program code that is executed by the at least one processor to perform operations comprising determine a decision about delivery of power from the local battery to the at least one radio head for a future time window. The decision is made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window. The operations further include output the decision about delivery of power from the local battery to the at least one radio head for the future time window.

In other embodiments, a computing device in a communication system for management of delivery power to at least one radio head from a local battery located proximate to the at least one radio head is provided. The computing device is adapted to perform operations comprising determine a decision about delivery of power from the local battery to the at least one radio head for a future time window. The decision is made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window. The operations further include output the decision about delivery of power from the local battery to the at least one radio head for the future time window.

In other embodiments, a computer program comprising program code to be executed by processing circuitry of a computing device is provided, the computing device in a communication system for management of delivery of power to at least one radio head from a local battery located proximate to the at least one radio head. Execution of the program code causes the computing device to perform operations comprising determine a decision about delivery of power from the local battery to the at least one radio head for a future time window. The decision is made by a machine learning model based on (i) differentiation of output power data statistics comprising average power demand and peak power demands over a set of past time windows covering a defined time period for the at least one radio head, and (ii) time and location dependent cost data of charging and/or discharging the local battery and power grid utilization for the future time window. The operations further include output the decision about delivery of power from the local battery to the at least one radio head for the future time window.

In other embodiments, a computer program product comprising a non-transitory storage medium including program code to be executed by processing circuitry of a computing device is provided, the computing device in a communication system for management of delivery of power to at least one radio head from a local battery located proximate to the at least one radio head. Execution of the program code causes the computing device to perform operations comprising determine a decision about delivery of power from the local battery to the at least one radio head for a future time window. The decision is made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window. The operations further include output the decision about delivery of power from the local battery to the at least one radio head for the future time window.

Certain embodiments may provide one or more of the following technical advantages. As discussed above, method of some embodiments can manage delivery of power to at least one radio head from a local battery located proximate to the at least one radio head. The method includes determining a decision about delivery of power from the local battery to the at least one radio head for a future time window. The decision is made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window; and outputting the decision about delivery of power from the local battery to the at least one radio head for the future time window. As a consequence, a technical advantage provided by the method may include cost savings for energy based on charging and/or discharging of the local battery for peak power demands. Additionally, peak shaving at a radio head may be enhanced based on management of the local battery using ML. Such management may not only provide and/or optimize local battery charge/discharge policies, but also may increase the lifetime of a local battery due to the decision and output of the decision.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic overview illustrating a conventional RAN site deployment;

FIG. 2 is a schematic overview illustrating addition of radio heads to an existing conventional RAN site;

FIG. 3 is a schematic overview illustrating the additional radio heads of the RAN site of FIG. 2 in accordance with some embodiments of the present disclosure;

FIG. 4 is a plot of input power to four radio heads in a two-sector radio site for a day;

FIG. 5 is the plot of FIG. 4 annotated in accordance with some embodiments of the present disclosure;

FIG. 6 is a schematic overview illustrating states of charge for a local battery in accordance with some embodiments of the present disclosure;

FIG. 7 is a sequence diagram illustrating operations in accordance with some embodiments of the present disclosure;

FIG. 8 is sequence diagram illustrating operations in accordance with some embodiments of the present disclosure;

FIG. 9 is a block diagram illustrating a computing device according to some embodiments of the present disclosure;

FIGS. 10 and 11 are flow charts illustrating operations of a computing device node according to some embodiments of the present disclosure;

FIG. 12 is a block diagram of a communication system in which a communication system in accordance with some embodiments of the present disclosure can be implemented;

FIG. 13 is a block diagram of a network node in accordance with some embodiments of the present disclosure;

FIG. 14 is a block diagram of a host computer communicating with a user equipment in accordance with some embodiments of the present disclosure; and

FIG. 15 is a block diagram of a virtualization environment in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

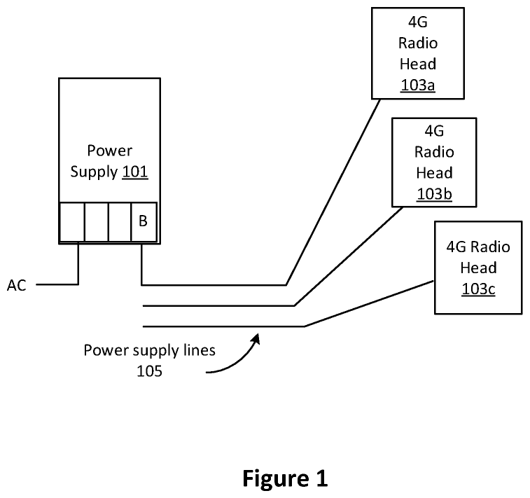

FIG. 1 is a schematic overview illustrating a conventional RAN site deployment. As illustrated in FIG. 1, a power supply 101 is connected to three 4G radio heads (also referred to as radio units) 103a, 103b, 103c via power supply lines 105. Power supply 101 also includes a backup battery (labelled “B” in FIG. 1).

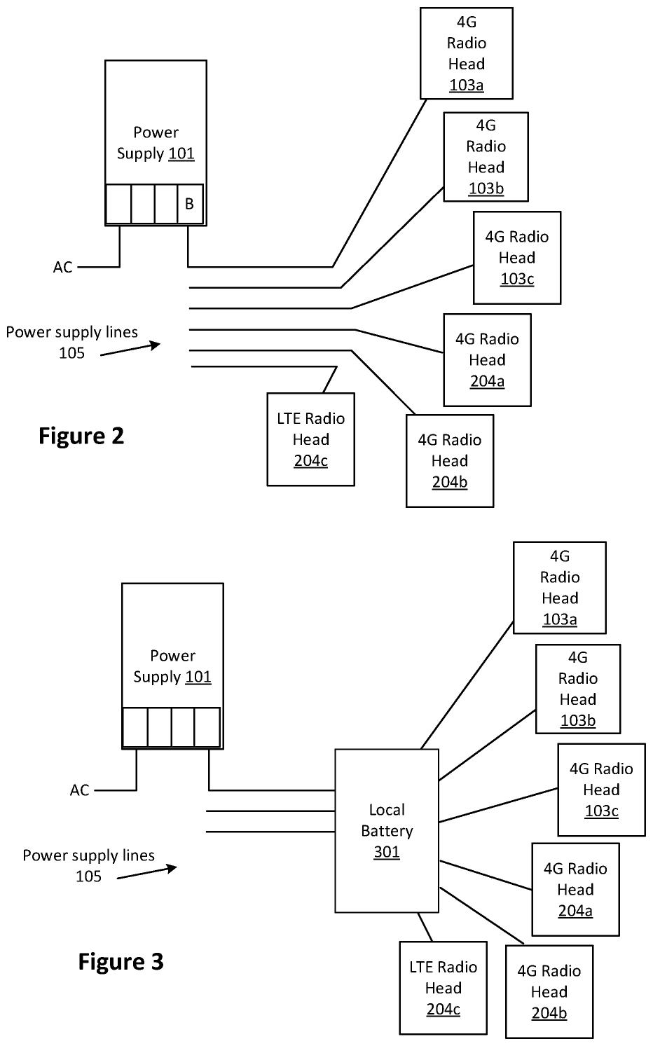

FIG. 2 is a schematic illustrating addition of radio heads to an existing conventional RAN site (e.g., to the RAN site of FIG. 1). As illustrated in FIG. 2, three additional radio heads 204a, 204b, 204c have been added to the RAN site of FIG. 1 and are connected to power supply 101 via three additional power supply lines 105, such that there six power lines running from the power supply 101 to each of radio heads 103a, 103b, 103c, 204a, 204b, and 204c, respectively.

“Peak shaving” is a term that refers to cutting the power in utilities when the demand from consumers is high. Some references discuss an architecture that controls peak shaving for utility and/or power transmission lines.

There currently exist certain challenge(s).

An architecture that controls peak shaving for utility and/or power transmission lines behaves differently from a power system having an integrated local backup battery in a site for radio communications as illustrated, for example, in FIGS. 1 and 2. Radio communications add nontrivial challenges and new variables in terms of radio network load and target key performance indicators (KPIs) that vary over time.

Existing approaches for site infrastructure include a backup battery (e.g., B in FIGS. 1 and 2) for use as a backup in case of a power outage. The site backup battery B typically is dimensioned according to local regulations (e.g., hours) and an average power consumption need for the site. As a consequence, site dimensioning (e.g., power cables, circuit breakers, PSU) is often made based on the maximum radio power consumption of each radio unit, which highly affects and increases the incoming site fuse. Increasing a site fuse rating, however, can have a significant adverse impact on the operational cost to the operator.

Additionally, approaches that add additional radio units to an existing RAN site (e.g., as illustrated in FIG. 2) lack differentiation between average and peak power demands for the radio units, and instead add more infrastructure (e.g., more power lines, fuses, etc.) to provide power needs for the additional radio heads (other than backup battery power) from a power grid via a power supply connected to the power grid. Such differentiation between average and peak power, however, is important to optimally/improve design and operation of a local battery (ies) so as to make the process of adding new radio access technologies (RATs) more sustainable while reducing total carbon footprint of radio network operation.

There is a need for improving site infrastructure and method for delivering power in a way that enables the differentiation between average and peak power of radio heads, while still adding new RATs in a sustainable way (e.g., such that peak power needs are supplied from a local battery instead of from a power grid).

Certain aspects of the disclosure and their embodiments may provide solutions to these or other challenges. Certain embodiments of the present disclosure include a method using machine learning (ML) to differentiate between average power usage and peak power usage of different radio heads. A local battery provides supplementary power that handles peak power consumption of a radio head(s). The local battery is located proximate to the radio heads. Power lines from a site power supply deliver average power to the radio heads.

Certain embodiments may provide one or more of the following additional technical advantages. As discussed above, in some embodiments, a method is provided for managing delivery of power to at least one radio head from a local battery located proximate to the at least one radio head. The method includes determining a decision about delivery of power from the local battery to the at least one radio head for a future time window. The decision is made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window; and outputting the decision about delivery of power from the local battery to the at least one radio head for the future time window.

As a consequence of locating the local battery proximate to a radio head(s), the decision, and the output of the decision about delivery of power from the local battery, a reduction in the number or length of power lines (also referred to herein as “cables”) and fuses needed may be provided; and expanding a site with additional radio heads may be facilitated with fewer or shorter power lines. For example, when radio heads are added to an existing conventional RAN site (e.g., to the RAN site of FIG. 1), based on inclusion of the local battery proximate the radio heads (e.g., as illustrated in FIG. 3 discussed further herein), the number of power lines from a power supply (e.g., power supply 101) to the local battery (e.g., local battery 301) can remain the same (e.g., the three power lines 105). This is in contrast to existing approaches for expanding a site with additional radio heads where new power lines are installed that run the complete distance from the power supply to the new radio heads. In the example of FIG. 2, three additional power lines are added such that there are six power lines covering the complete distance between the power supply (e.g., power supply 101) and the radio heads (e.g., radio heads 103a-103b and 104-a-104c as illustrated in FIG. 2). Moreover, based on inclusion of local battery management for radio peak power, operators of radio systems may provide robustness to power-grid failures because the local battery is an active power source (e.g., not merely a back-up power source). Additional technical advantages of inclusion of a local battery proximate a radio head(s) for managing delivery of power to the radio head(s) may include: use of green energy sources to charge the local battery (as opposed, e.g., to use of a power grid to power the radio heads and/or charge a backup battery located at a power grid power supply), which may contribute toward zero-emission RAN, as well as increasing network robustness to power-grid failures.

FIG. 3 is a schematic illustrating the additional radio heads 204a, 204b, 204c of FIG. 2 but where the RAN site is configured in accordance with some embodiments of the present disclosure. The architecture of FIG. 3 can enable local radio head peak shaving based on inclusion of local battery 301. In accordance with certain embodiments of the present disclosure, a method for management of peak power consumption of at least one radio head 103a-103c, 204a-204c from local battery 301 differentiates between average and radio peak power and manages delivery of power from two different sources 101, 301 during the normal network operation.

In FIG. 2, a backup battery B is a backup power source and additional radio heads 204a-204c were added to the site including a different RAT, e.g., LTE expansion radio head 204c. In contrast, FIG. 3 illustrates a site design that adds local battery 301, which allows for peak shaving while reducing the number of cables and fuses needed, while still adding the additional radio heads 204a-204c. In the example embodiment of FIG. 3, based on inclusion of local battery 301 as an active power supply (i.e., not a battery back-up), the number of cables 105 from power supply 101 compared to FIG. 2 is reduced. In FIG. 2, the additional of radio heads 204a-204c also added three power cables 105 covering the complete distance between power supply 101 and radio heads 204a-204c, such that there are six power lines 105 covering the complete distance between power supply 101 and radio heads 103a-103c and 204a-204c, respectively. In contrast, in FIG. 3, adding radio heads 204a-204c did not add power lines 105 between the power supply 101 and local battery 101. Thus, in contrast to FIG. 2, in FIG. 3 the number and/or length of power lines 105 is reduced . . . . Additionally, in FIG. 3, because local battery 301 is an active power supply for peak power demands, incoming power from the grid via power supply 101 may be reduced.

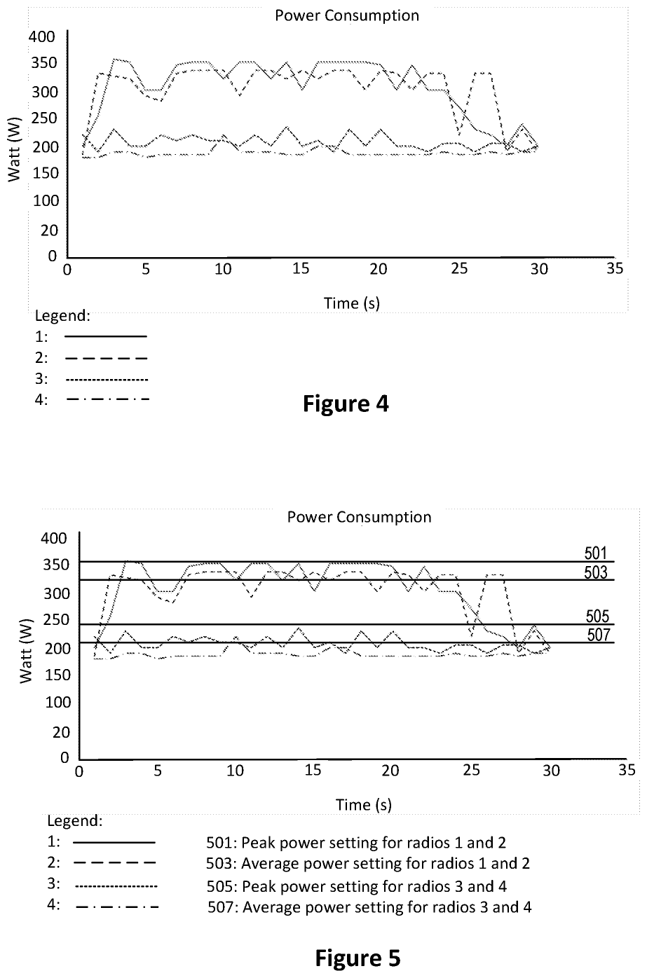

FIG. 4 is a plot of input power to four radio heads (radio heads 1, 2, 3, 4 as shown in the legend) in a two-sector radio site for a defined time period of about 30 seconds. The solid line and the dashed line show radios 1 and 2 of a first sector. The dotted line and the dash-dot line show radios 3 and 4 of the second sector. As is can be seen from the illustrated plot in FIG. 4, the radio heads have different average power and power peaks in Watts over the time period.

FIG. 5 is the plot of FIG. 4 annotated with horizontal lines 501, 503, 505, 507 that illustrate average power and peak power differentiation for the radio heads for the time period in accordance with some embodiments of the present disclosure. In the example embodiment of FIG. 5, it can be seen from the illustrated plot that, given the separation between average power shown by lines 503, 507 and peak power shown by lines 501, 505, respectively, appropriate dimensioning of a powerline(s) 105 can carry the average power 503, 507 of radio units, while the peak power 501, 505 can be controlled from local battery 301.

While FIGS. 4 and 5 are described with reference to four radio heads and a defined time period of about 30 seconds, embodiments of the present disclosure are not so limited. Instead, any quantity of radio heads of one or more may be included; and the defined time period may be any time period defined in seconds, minutes, hours, a day(s), a week, etc. Moreover, while two peak power settings and two average power settings are shown for the illustrated plot in FIG. 5, embodiments of the present disclosure are not so limited. Instead, a peak power setting may be identified/determined (as discussed further herein) on a per radio head basis and/or for one or more radio heads. Additionally, an average power setting may be identified/determined (as discussed further herein) on a per radio had basis and/or for one or more radio heads. Moreover, while some embodiments are described herein with reference to average power supplied by a power grid and peak power supplied by a local battery, embodiments of the present disclosure are not so limited. Instead, an amount of power greater than or less than the peak power may be supplied by the local battery, and remaining power needs of the radio head(s) may be supplied from the power grid.

In accordance with certain embodiments of the present disclosure, a ML-based method can manage charge and discharge policies of the local battery 301 for peak shaving, based on the temporal variations of radio power peak demands as well as power grid energy price for a temporal period and carbon footprint profile.

In some embodiments, the following observations are considered:
There can be a significant variation on the input and power output of radio heads. Some radio heads are very active with high power, while others may barely reach a high output power.
There is a high correlation between peak of power of a radio head related to incoming power from a site power supply (and power grid) and the output power of radio heads (which peaks with the peak of a traffic load).
Differentiation is needed between average and peak radio power for active time windows where the radio heads are substantially inactive (see e.g., FIG. 4). Such differentiation may support efficient operation of the local battery 301.
There is a high temporal correlation between output powers of a single radio head (e.g., during overnight time periods).

In some embodiments, these observations are used to build a ML method for managing a local battery (e.g., battery 301).

In some embodiments, a defined time period (e.g., a day) is divided into a set of time windows (e.g., for every hour) and decision variables are generated for a future time window(s). The method uses data collected or accessed from power consumptions of radio heads (including radio traffic variations) over time to train a ML model (e.g., a RL agent).

Training of the RL agent includes at least the following inputs: (1) local battery capacity; (2) average power consumption of all radio heads over the past K time windows from the set of time windows, for a predefined integer K>0; (3) peak power consumptions of every radio head over the past K time windows from the set of time windows; and (4) Costs of charging the local battery in a current or future time window as well as cost of using the power grid. The RL agent optimizes, for the beginning of a current/future time window(s) (e.g., each time window), state of charge decisions that include when to charge the local battery; when and how much to discharge the local battery for a radio head(s); and not to deliver power from the local battery to a radio head(s) (e.g., when a state of charge decision is to discharge an amount of zero from the local battery for a radio head(s)).

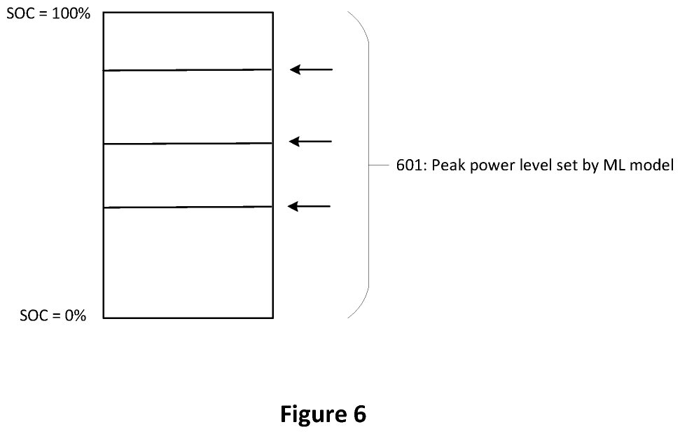

FIG. 6 is a schematic overview illustrating states of charge (SOC) for a local battery in accordance with some embodiments of the present disclosure. As illustrated in FIG. 6, the SOC level of the local battery ranges from 0% to 100%. The ML model (e.g., a RL model) defines/sets a SOC for the local battery for a forecasted radio peak power for a future time window(s) (e.g., for each future time window). The SOC level can vary between 0% and 100% and is defined at a SOC level depending on the forecasted peak power. In the example embodiment of FIG. 6, the SOC level can be set for a future time window at an SOC level indicated by the three arrows. While the example of FIG. 6 illustrates three SOC levels, the invention is not so limited and the SOC level can be defined at any non-zero SOC level depending on the forecasted peak power.

In some embodiments, the SOC decision (also referred to herein as a “decision”) meets the following four constraints for a time window(s):
C1. Constraint 1: Local battery discharge level of any time window to a radio head plus power input (from power cables) at every time should be identical to input power needed for that radio head at that time. These time-location stamped input powers are given in the dataset and are inputs/constants to the ML model.
C2. Constraint 2: Local battery discharge at every time window should not exceed local battery level at the beginning of this time window plus charging profile limit of that time window.
C3. Constraint 3: Current local battery level is identical to previous local battery level plus charging in this time window.
C4. Constraint 4: Local battery level in any time window should not exceed the local battery capacity.

An objective of the method is to minimize a total cost, including the cost of charging the local battery and the cost of using the power grid, for a future time window(s) by allowing the average power to radio heads to come from a site power system based on inclusion of the constraints.

A ML model will now be discussed further. In some embodiments, the ML model is an episodic RL agent where each episode is a defined time period (e.g., a day). In some embodiments, the RL agent is trained at the cloud and then deployed at a battery management service location (e.g., located at the local battery of a site(s)).

In some embodiments, the RL agent uses a dataset of power consumption of radio heads over the defined time period, differentiated between radio average power and radio peak power for an episode or for many episodes (e.g., days).

In some embodiments, actions include charge and discharge decisions for at least one local battery for the radio heads.

In some embodiments, states include current local battery level, current output power of every radio head, and current local battery charging cost.

In some embodiments, the reward for the RL agent at every state-action pair is to minimize the total cost of input power in the next time window in a set of time windows. The total cost is a weighted sum of power from the grid and power from the local battery, weighted based on their own costs. In some embodiments, the total cost includes, among others, monetary cost of energy or a carbon footprint index.

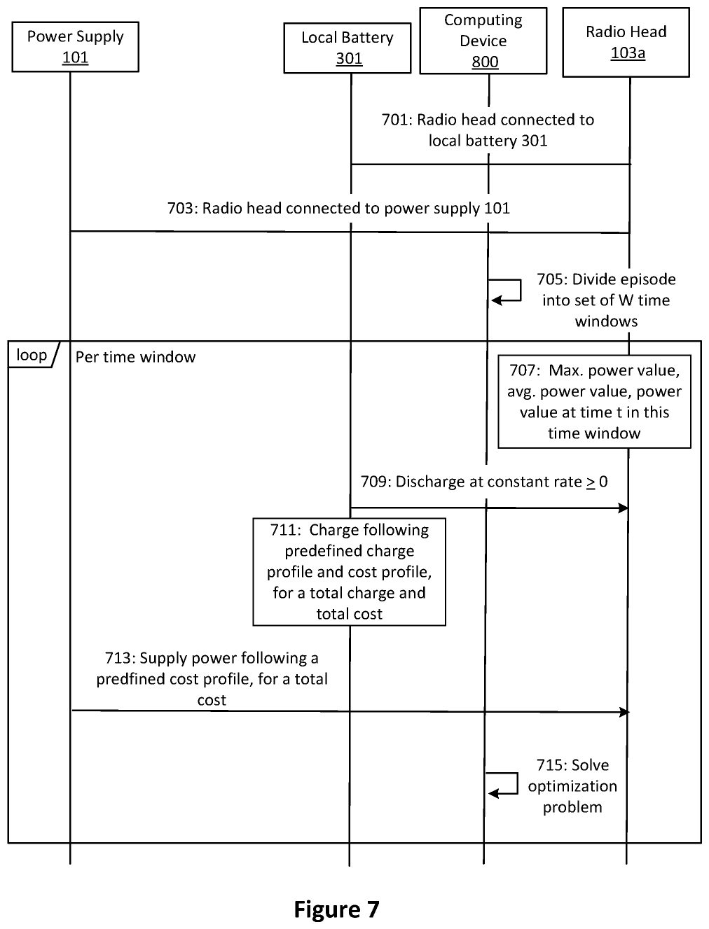

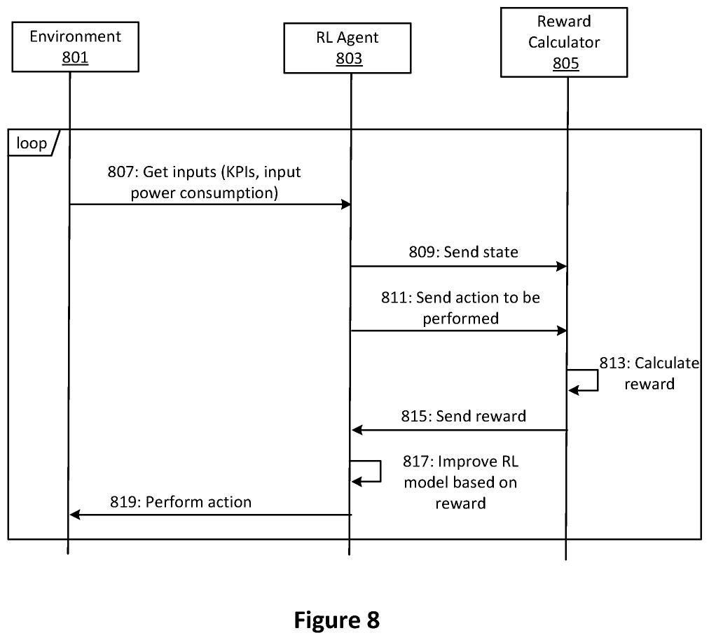

An example embodiment is now discussed with reference to FIG. 7. While the example embodiment of FIG. 7 is discussed in the context of FIG. 3 which illustrates one local battery and six radio heads, the various embodiments of the present disclosure are not so limited and can include different quantities of local batteries and different quantities or types of radio heads. Moreover, while certain embodiments are discussed with reference to one local battery for ease of discussion, the various embodiments of the present disclosure are not so limited and may include any quantity of local batteries.

Referring to FIG. 7, in the example embodiment, a total of R radio heads (e.g., radio heads 103a-103c and 204a-204c), indexed by i∈{1, 2, . . . , R} (R=6 in this example embodiment), are connected to a local battery 301 of capacity C, as illustrated by connection 701 The radio heads are also connected to a power grid via power supply 101, as illustrated by the connection 703. In operation 705, a computing device (e.g., computing device 900 as discussed further herein) divides every episode (that is, a decision-making defined time period such as every day) into a set of W time windows of predefined duration T, and B_{w} denotes the local battery 301 level at the beginning of a future time window w from the set of time windows. As shown in operation 709, in every window w, each radio head i among the radio heads (e.g., radio head as illustrated for radio head 103a in FIG. 7) has a max power p_{iw}^{max}, an average power of p_{iw}^{avg}, and a power p_{iw}(t) at any time t in this time window. In every time window w, the local battery 301 discharges to radio head i at a constant rate of d_{iw}^{b}≥0. As shown in box 711, charging the local battery 301 at every time window w follows a predefined charge profile h_{w}^{b}(t) and cost profile of c_{w}^{b}(t), leading to a total charge of H_{w}^{b}=∫ₜ₌₀^{T}h_{w}^{b}(t)dt with a total cost of C_{w}^{b}=∫ₜ₌₀^{T}d_{iw}^{b}c_{w}^{b}(t) dt during this time window. Moreover, as shown in operation 713, using the power grid via power supply 101 at every time window w follows a predefined cost profile of c_{w}^{g}(t), leading to a total cost of c_{iw}^{g}=∫ₜ₌₀^{T}d_{iw}^{g}(t)c_{w}^{g}(t)dt, where d_{iw}^{g}(t) is the power grid usage at time t for radio head i.

Still referring to FIG. 7, the following constraints are included at every time window in the set of time windows:
First constraint: Input power to radio heads: d_{iw}^{b}+d_{iw}^{g}=p_{iw}(t).
Second constraint: Local battery level (this includes Constraints 2-4 discussed above):

$${B}_{w} + {H}_{w}^{b} - {Td}_{iw}^{b} ∈ [ 0 , C ] .$$

The cost of operation (e.g., energy bill) in every time window is C_{w}^{b}+C_{w}^{g} leading to a cost of ƒ(d₁₁^{b}, d₁₂^{b}, . . . , d_{RW}^{b})=Σ_{w∈W}C_{w}^{b}+Σ_{i∈R}C_{iw}^{g} for the entire episode. An optimization problem is, thus, formulated as follows, where ƒ is the reward function:

$$\begin{matrix}minimize & f ( {d}_{11}^{b} , {d}_{12}^{b} , … , {d}_{RW}^{b} ) \\ subject to & C 1 and C 2\end{matrix}$$

The reward function ƒ, thus, minimizes the cost ƒ(d₁₁^{b}, d₁₂^{b}, . . . , d_{RW}^{b})=Σ_{w∈W}C_{w}^{b}+Σ_{i∈R}C_{iw}^{g}, for the entire episode constrained by C1 (i.e., local battery discharge level of any time window to a radio head plus power input (from power cables) at every time should be identical to input power needed for that radio head at that time) and C2 (i.e., local battery discharge at every time window should not exceed local battery level at the beginning of this time window plus charging profile limit of that time window).

As indicated in operation 715, the RL agent of computing device 900 solves the optimization problem. In some embodiments, the RL agent has access to historical data of power consumption {p_{iw}(t)} for many past episodes, as well as the cost profile of charging the local battery 301 and using the power grid c_{w}^{g}(t) via power supply 101 The RL agent uses that dataset to simulate the environment.

FIG. 8 is a sequence diagram illustrating operations for management of peak power demand of one or more radio head(s) from a local battery in accordance with some embodiments of the present disclosure. In the example embodiment of FIG. 8, the ML model is a RL agent 803. Environment 801 is (i) a simulator based on collected data during training key performance indicators (KPIs) and power data, or (ii) after deployment of the RL agent 803 and the local battery (ies), an actual network in which KPIs and power data is measured. KPIs include, without limitation, local battery and cost data including a capacity of the local battery, a first cost for charging the local battery in a future time window, and a second cost for using power from a power grid for an average power demand of at least one radio head in the future time window. Power data includes, without limitation, (i) an average power demand of at least one radio head over a set of past time windows, (ii) a peak power demand of the at least one radio head over the set of past time windows, and (iii) a traffic load of the at least one radio head over the set of past time windows.

Still referring to FIG. 8, at operation 807, RL agent 803 gets inputs including a KPI(s) and input power consumption from the Environment 801. In operation 809, RL agent 803 maps the inputs to an environment state, and sends the state to reward calculator 805. RL agent 803, in operation 811, computes a next action to be performed and sends the action to reward calculator 805. Reward calculator 805 calculates a reward in operation 813. In operation 815, RL agent 803 receives the reward and then, in operation 817 improves the RL model and actions based on the reward.

Still referring to FIG. 8, in some embodiments, during training, a loop of operations 807-819 is continued to determine the local battery management policy (e.g., an optimal battery management policy).

In some embodiments, after determining the local battery management policy, the trained RL agent 803 is deployed in an actual network. In some embodiments, the RL agent 803 is deployed at every site (e.g., at a battery management service location) or in the cloud. The deployed RL agent 803 can access data from the network and monitors KPIs for potential retraining/tuning of the RL agent. The operations 807-819 of the loop are performed in the actual network to determine the local battery management policy.

In some embodiments, at least one local battery has a set of functionalities that make the at least one local battery a supplementary source of power, including a decision and performance of actively charging and discharging to minimize some cost functions (e.g., for the operators).

In some embodiments, the at least one local battery is installed close to the radio heads, and the at least one local battery handles only the peak power consumption. Power cables, coming from a site power system for the radio heads (e.g., a power supply that is 60 m away from radio heads of the site) are set to only deliver average power to the radio heads. The at least one local battery has a local computation or SC decision for handling the peak power.

In some embodiments, the method differentiates between average power and several radio peak radio head consumptions in the state space, and a decision is provided to enable the local battery to deliver only the peak power to the radio heads.

In some embodiments, the method calculates per day the traffic variation and power demands and enables actuation of the at least one local battery (e.g., to charge or discharge for a peak power demand).

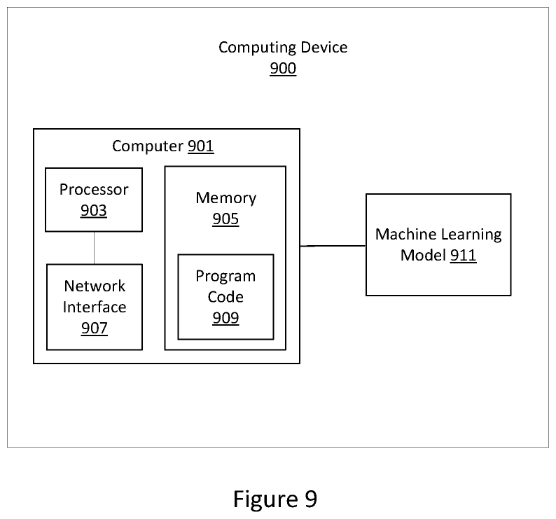

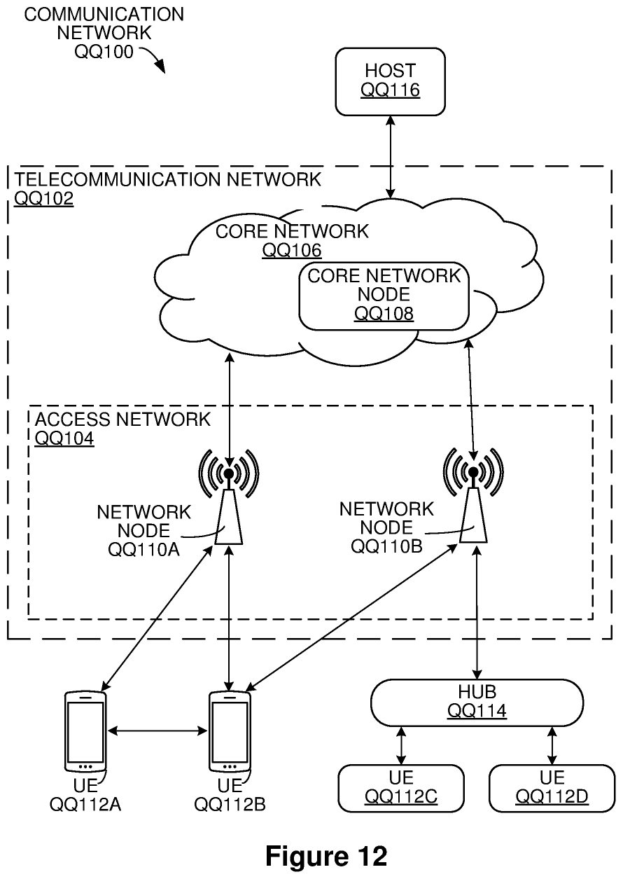

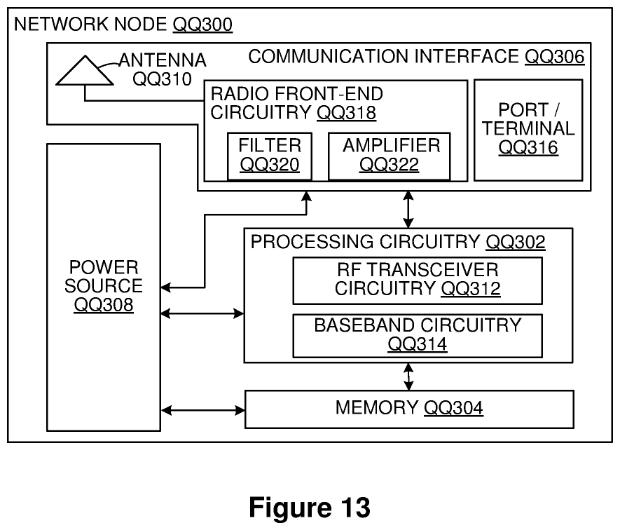

FIG. 9 is a block diagram illustrating elements of a computing device 900 (also referred to as a server, a cloud-based server, an edge server, a radio access network node, base station, radio base station, eNodeB/eNB, gNodeB/gNB, or any other functional physical or virtual network node on which a machine learning model, as disclosed herein, can be implemented) of a communication network (e.g., a communication network QQ100 configured to provide communication as discussed below with respect to FIG. 12) according to embodiments of inventive concepts. Computing device 900 may be provided, for example, as discussed below with respect to network node QQ110A, QQ110B of FIG. 12, network node QQ300 of FIG. 13, hardware QQ504 and/or virtual machine QQ508A, QQ508B of FIG. 15, all of which should be considered interchangeable in the examples and embodiments described herein and be within the intended scope of this disclosure, unless otherwise noted. As shown, the computing device may include a computer 901 communicatively connected to ML model 911. ML model 911 may be an episodic RL agent. ML model 911 may also include a reward calculator (e.g., reward calculator 705). Computer 901 may include transceiver circuitry (also referred to as a transceiver, e.g., corresponding to portions of RF transceiver circuitry QQ312 and radio front end circuitry QQ318 of FIG. 13) including a transmitter and a receiver configured to provide uplink and downlink radio communications with mobile terminals. The computer may include network interface circuitry 907 (also referred to as a network interface, e.g., corresponding to portions of communication interface QQ306 of FIG. 13) configured to provide communications with other devices or nodes (e.g., with other network nodes, communication devices, and/or data repositories) of the communication network. The computing device may also include processing circuitry 903 (also referred to as a processor, e.g., corresponding to processing circuitry QQ302 of FIG. 13) coupled to the transceiver circuitry, and memory circuitry 905 (also referred to as memory, e.g., corresponding to memory QQ304 of FIG. 13) coupled to the processing circuitry. The memory circuitry 905 may include computer readable program code that when executed by the processing circuitry 903 causes the processing circuitry to perform operations according to embodiments disclosed herein. According to other embodiments, processing circuitry 903 may be defined to include memory so that a separate memory circuitry is not required.

As discussed herein, operations of the computing device may be performed by processing circuitry 903, network interface 907, and/or transceiver. For example, processing circuitry 903 may control transceiver to transmit downlink communications through transceiver over a radio interface to one or more mobile terminals UEs and/or to receive uplink communications through transceiver from one or more communication devices over a radio interface. Similarly, processing circuitry 903 may control network interface 907 to transmit communications through network interface 907 to one or more other devices or network nodes and/or to receive communications through network interface from one or more network nodes, radio heads, local batteries, communication devices, etc. Moreover, modules may be stored in memory 905, and these modules may provide instructions so that when instructions of a module are executed by processing circuitry 903, processing circuitry 903 performs respective operations (e.g., operations discussed below with respect to Example Embodiments relating to computing devices). According to some embodiments, computing device 900 and/or an element(s)/function(s) thereof may be embodied as a virtual node/nodes and/or a virtual machine/machines, e.g., as discussed with reference to FIG. 15.

According to some other embodiments, a computing device may be implemented as a core network node without a transceiver. In such embodiments, transmission to a communication device, a network node, a radio head, a local battery, etc. may be initiated by the computing device 900 so that transmission to the communication device, network node, etc. is provided through a computing device 900 including a transceiver (e.g., through a base station or RAN node). According to embodiments where the computing device is a RAN node including a transceiver, initiating transmission may include transmitting through the transceiver.

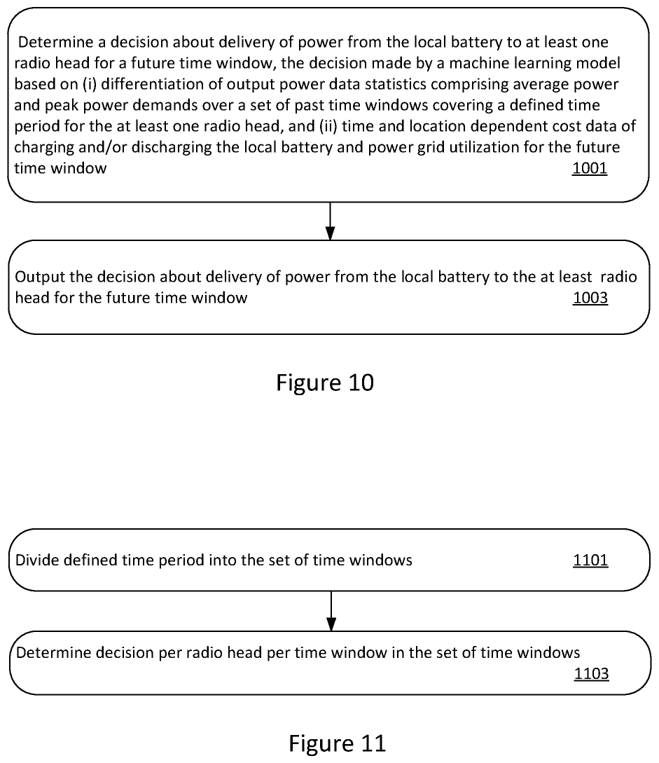

Operations of a computing device (e.g., a computing device including ML model 911) (implemented using the structure of FIG. 9) will now be discussed with reference to the flow charts of FIGS. 10 and 11 according to some embodiments of the present disclosure. In the description that follows, while the computing device may be any of the computing device 900, network node QQ110A, QQ110B, QQ300, QQ606, hardware QQ504, or virtual machine QQ508A, QQ508B, the computing device 900 shall be used to describe the functionality of the operations of the computing device. For example, modules may be stored in memory 905 of FIG. 9, and these modules may provide instructions so that when the instructions of a module are executed by respective computing device processing circuitry 903, processing circuitry 903 performs respective operations of the flow chart.

Referring to FIG. 10, a method is provided that is performed by a computing device (900) in a communication system for management of delivery of power to at least one radio head from a local battery located proximate to the at least one radio head. The method includes determining (1001) a decision about delivery of power from the local battery to the at least one radio head for a future time window. The decision is made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window. The method further includes outputting (1003) the decision about delivery of power from the local battery to the at least one radio head for the future time window.

In some embodiments, the output power data statistics include at least (i) an average power demand of the at least one radio head over the set of past time windows, and (ii) a peak power demand of the at least one radio head over the set of past time windows.

In some embodiments, the time and location dependent cost data includes a first cost for charging the local battery in the future time window, and a second cost for using power from a power grid for an average power demand at the at least one radio head in the future time window.

In some embodiments, the decision includes one of the following for the future time window (i) deliver power from the local battery to the at least one radio head during the future time window. The future time window includes a period of peak power consumption at the at least one radio head, (ii) charge the local battery during the future time window, and (iii) deliver no power from the local battery to the at least one radio head during the future time window.

In some embodiments, the decision is made by the machine learning model based on (i) inputting the power data and the battery and cost data to the machine learning model, and (ii) for the future time window, determining a minimized total cost for delivery of power to the at least one radio head when constrained by a plurality of constraints for the future time window.

In some embodiments, the plurality of constraints include (i) a first constraint set as an input power consistency where the input power to a radio head is equal to a discharge level of the local battery to that radio head plus power from the power grid, and (ii) a second constraint set as a discharge from the local battery where the discharge is less than or equal to a charge level of the local battery at the start of the future time window plus a charging profile limit of the future time window.

In some embodiments, the charging profile limit of the future time window includes further constraints. The further constraints include (i) a third constraint set as a current level of charge of the local battery where the current level of charge is identical to a previous level of charge of the local battery plus an amount of charging minus discharging of the local battery in the current time window, and (ii) a fourth constraint set as a level of charge of the local battery in any window in the set of time windows where the level of charge is less than or equal to a charge capacity of the local battery.

In some embodiments, the machine learning model receives a reward feedback for a state and action pair. The state includes a current level of charge of the local battery, a current input power of the at least one radio head, and a current cost for charging the local battery. The action in the state and action pair includes the decision.

Referring now to FIG. 11, in some embodiments, the at least one radio head includes a plurality of radio heads. The method further includes dividing (1101) the defined time period into the set of time windows. The method further includes determining (1103) the decision per radio head per time window in the set of time windows.

Referring again to FIG. 10, in some embodiments, the outputting (903) the decision includes outputting the decision to control the delivery of power to the at least one radio head based on the decision.

In some embodiments, the power data is offline data, and the determining (1001) and the outputting (1003) are performed during training of the machine learning model using the offline data.

In some embodiments, the power data is online data, the machine learning model is deployed in the communication system, and the determining (1001) and the outputting (1003) are performed by the deployed machine learning model.

In some embodiments, the computing device is located at one of proximate the local battery and a cloud-based location.

The various operations from the flow chart of FIG. 11 may be optional with respect to some embodiments of a method performed by a computing device.

FIG. 12 shows an example of a communication network QQ100 in which a communication system in accordance with some embodiments can be implemented.

In the example, the communication network QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections. Network nodes QQ110A, QQ110B may be a cloud-implemented network node (e.g., a server) or an located in the cloud or an edge-implemented network node (e.g., a server). Network nodes QQ110A, QQ110B facilitates direct or indirect connection of communication devices, such as by connecting communication devices QQ112a, QQ112b, QQ112c, and QQ112d (one or more of which may be generally referred to as communication devices/UEs QQ112) to the communication network QQ100 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication network QQ100 may include any number of wired or wireless networks, network nodes, communication devices, and/or any other components or systems that may facilitate or participate in the communication of data and/or signals whether via wired or wireless connections. The communication network QQ100 may include and/or interface with any type of communication, telecommunication, data, cellular, radio network, and/or other similar type of system including, but not limited to, a 5G and/or 6G network.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication network QQ100 of FIG. 12 enables connectivity between the UEs, network nodes, and hosts. In that sense, the communication network may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 13 shows a network node QQ300 in accordance with some embodiments (e.g., network node QQ300 may comprise a network node on which computing device 900 can be implemented). As used herein, network node refers to equipment capable, configured, arranged and/or operable to communicate directly or indirectly with a UE and/or with other network nodes or equipment, in a communication network. Examples of network nodes include, but are not limited to, servers, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), Minimization of Drive Tests (MDTs), and/or cloud-implemented servers or edge-implemented servers.

The network node QQ300 includes a processing circuitry QQ302, a memory QQ304, a communication interface QQ306, and a power source QQ308. The network node QQ300 may be composed of multiple physically separate components (e.g., a clustering component, a database (e.g., knowledge graph) component, a NodeB component and a RNC component, or a BTS component and a BSC component, etc.), which may each have their own respective components. In certain scenarios in which the network node QQ300 comprises multiple separate components (e.g., clustering and database components), one or more of the separate components may be shared among several network nodes. For example, a single network node may control multiple network nodes comprising clustering components and/or databases (e.g., repositories). In such a scenario, each unique network node and component pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same database or a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

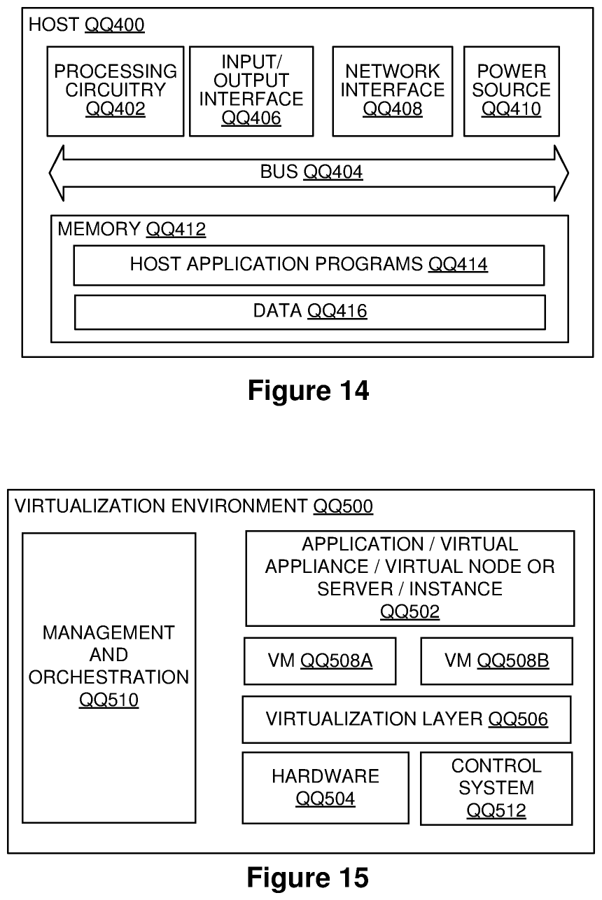

FIG. 14 is a block diagram of a host QQ400, which may be an embodiment of the host QQ116 of FIG. 12 and which may be a host on which computing device 900 can be implemented, in accordance with various aspects described herein. As used herein, the host QQ400 may be or comprise various combinations hardware and/or software, including a standalone server, a blade server, a cloud-implemented server, an edge-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 17 and 18, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment QQ500 in which functions of computing device 900 can be implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Although the computing device described herein (e.g., network nodes, servers, hosts, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, communication devices and network nodes may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a communications system (e.g., a wireless network) generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method performed by a computing device in a communication system for management of delivery of power to at least one radio head from a local battery located proximate to the at least one radio head, the method comprising:
determining a decision about delivery of power from the local battery to the at least one radio head for a future time window, the decision made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window; and
outputting the decision about delivery of power from the local battery to the at least one radio head for the future time window.

2. The method of claim 1, wherein the output power data statistics comprise at least (i) an average power demand of the at least one radio head over the set of past time windows, and (ii) a peak power demand of the at least one radio head over the set of past time windows.

3. The method of claim 1, wherein the time and location dependent cost data comprises a first cost for charging the local battery in the future time window, and a second cost for using power from a power grid for an average power demand at the at least one radio head in the future time window.

4. The method of claim 1, wherein the decision comprises one of the following for the future time window (i) deliver power from the local battery to the at least one radio head during the future time window, the future time window comprising a period of peak power consumption at the at least one radio head, (ii) charge the local battery during the future time window, and (iii) deliver no power from the local battery to the at least one radio head during the future time window.

5. The method of claim 1, wherein the decision is made by the machine learning model based on (i) inputting the power data and the battery and cost data to the machine learning model, and (ii) for the future time window, determining a minimized total cost for delivery of power to the at least one radio head when constrained by a plurality of constraints for the future time window.

6. The method of claim 5, wherein the plurality of constraints comprise (i) a first constraint set as an input power consistency where the input power to a radio head is equal to a discharge level of the local battery to that radio head plus power from the power grid, and (ii) a second constraint set as a discharge from the local battery where the discharge is less than or equal to a charge level of the local battery at the start of the future time window plus a charging profile limit of the future time window.

7. The method of claim 6, wherein the charging profile limit of the future time window includes further constraints, the further constraints comprising (i) a third constraint set as a current level of charge of the local battery where the current level of charge is identical to a previous level of charge of the local battery plus an amount of charging minus discharging of the local battery in the current time window, and (ii) a fourth constraint set as a level of charge of the local battery in any window in the set of time windows where the level of charge is less than or equal to a charge capacity of the local battery.

8. The method of claim 1, wherein:
the machine learning model receives a reward feedback for a state and action pair, and wherein
the reward feedback is a value that minimizes the total cost of input power to the at least one radio head for a next window in the set of time windows,
the state comprises a current level of charge of the local battery, a current input power of the at least one radio head, and a current cost for charging the local battery, and
the action in the state and action pair comprises the decision.

9. The method of claim 1, wherein the at least one radio head comprises a plurality of radio heads, and further comprising:
dividing the defined time period into the set of time windows; and
determining the decision per radio head per time window in the set of time windows.

10. The method of claim 1, wherein the outputting the decision comprises outputting the decision to control the delivery of power to the at least one radio head based on the decision.

11. The method of claim 1, wherein:
the power data is offline data, and
the determining and the outputting are performed during training of the machine learning model using the offline data.

12. The method of claim 1, wherein:
the power data is online data,
the machine learning model is deployed in the communication system, and
the determining and the outputting are performed by the deployed machine learning model.

13. The method of claim 1, wherein the computing device is located at one of proximate the local battery and a cloud-based location.

14. A computing device in a communication system for management of delivery of power to at least one radio head from a local battery located proximate to the at least one radio head, the computing device comprising:
at least one processor;
at least one memory connected to the at least one processor and storing program code that is executed by the at least one processor to perform operations comprising:
determine a decision about delivery of power from the local battery to the at least one radio head for a future time window, the decision made by a machine learning model based on (i) differentiation of power output data statistics comprising average power and peak power demands over a set of past time windows covering a defined time period for the at least one radio head, and (ii) time and location dependent cost data of charging and/or discharging the local battery and power grid utilization for the future time window; and
output the decision about delivery of power from the local battery to the at least one radio head for the future time window.

15. The computing device of claim 14, wherein the output power data statistics comprise at least (i) an average power demand of the at least one radio head over the set of past time windows, and (ii) a peak power demand of the at least one radio head over the set of past time windows.

16.-19. (canceled)

20. A computer program product comprising a non-transitory storage medium including program code to be executed by processing circuitry of a computing device in a communication system for management of delivery of power to at least one radio head from a local battery located proximate to the at least one radio head, whereby execution of the program code causes the computing device to perform operations comprising:
determine a decision about delivery of power from the local battery to the at least one radio head for a future time window, the decision made by a machine learning model based on (i) differentiation of output power data statistics comprising average power and peak power demands over a set of past time windows covering a defined time period for the at least one radio head, and (ii) time and location dependent cost data of charging and/or discharging the local battery and power grid utilization for the future time window; and
output the decision about delivery of power from the local battery to the at least one radio head for the future time window.

21. The computer program product of claim 20, wherein the output power data statistics comprise at least (i) an average power demand of the at least one radio head over the set of past time windows, and (ii) a peak power demand of the at least one radio head over the set of past time windows.

22. The computing device of claim 14, wherein the time and location dependent cost data comprises a first cost for charging the local battery in the future time window, and a second cost for using power from a power grid for an average power demand at the at least one radio head in the future time window.

23. The computing device of claim 14, wherein the decision comprises one of the following for the future time window (i) deliver power from the local battery to the at least one radio head during the future time window, the future time window comprising a period of peak power consumption at the at least one radio head, (ii) charge the local battery during the future time window, and (iii) deliver no power from the local battery to the at least one radio head during the future time window.
